(19) United States
(12) Patent Application Publication
(10) Pub. No.: US 2018/0004490 A1
(43) Pub. Date: Jan. 4, 2018

(54) NON-TRANSITORY COMPUTER-READABLE STORAGE MEDIUM, EDITING SUPPORT METHOD, AND EDITING SUPPORT DEVICE

(71) Applicant: FUJITSU LIMITED, Kawasaki-shi (JP)

(72) Inventor: Masahiro Ichikawa, Susono (JP)

(73) Assignee: FUJITSU LIMITED, Kawasaki-shi (JP)

(21) Appl. No.: 15/634,320

(22) Filed: Jun. 27, 2017

(30) Foreign Application Priority Data
Jul. 1, 2016 (JP) 2016-131595

(51) Int. Cl. G06F 9/44

(52) U.S. Cl. CPC G06F 8/315

(57) ABSTRACT

An editing support method executed by a computer, the editing support method including obtaining, from a specified command statement included in a first source code, information designating a second source code and a first replacement rule by which a text included in the second source code is replaced, specifying a storage location of the second source code, obtaining the second source code based on the storage location, generating a third source code by substituting the text included in the second source code in accordance with the first replacement rule, when editing to the third source code is accepted, generating a fourth source code by substituting a text included in the third source code in accordance with a second replacement rule, the second replacement rule indicating a replacement opposite to the first replacement rule, and updating the second source code stored in the specified storage location to the fourth source code.

### CROSS-REFERENCE TO RELATED APPLICATION

This application is based upon and claims the benefit of priority of the prior Japanese Patent Application No. 2016-131595, filed on Jul. 1, 2016, the entire contents of which are incorporated herein by reference.

### FIELD

The embodiment discussed herein is related to a non-transitory computer-readable storage medium, an editing support method, and an editing support device.

### BACKGROUND

In recent years, a legacy system using a COBOL language or the like has been often shifted to an open system or maintained rather than newly developed. In addition, there are many cases where a replaced engineer maintains systems developed in the past. For this reason, improvement of maintainability is desired for a development environment of a language used for such the legacy system.

As the related art, a technology to unify and standardize a record definition into the same copy statement, and to improve efficiency of correction work of developed software in addition to a data item, a file name, and attributes is suggested (see, for example, Japanese Laid-open Patent Publication No. 05-204625). In addition, a technology to standardize and unify synonymous data items for an existing software product is suggested (see, for example, Japanese Laid-open Patent Publication No. 06-131164). In addition, a technology in which an input program written by a first grade programming language is converted into an object program written by a second grade programming language is suggested (see, for example, Japanese Laid-open Patent Publication No. 2010-134487).

In addition, a technology to display a replaced value in a read-only mode in a case of displaying the replaced value in a copybook referenced by using a COPY . . . REPLACING statement of the COBOL language is suggested (see, for example, “Expanded Copybook View”, [online], product manual of Microfocus Corporation, [search on Jun. 6, 2017], Internet <URL: http://documentation.microfocus.com/help/idex.jsp?top=%2Fcom.microfocus.eclipse.infocenter.visualcobol.vs2015%2FGUID-A2EA4D2F-6198-4D61-8573-425091D14399.html>).

### SUMMARY

According to an aspect of the invention, a non-transitory computer-readable storage medium storing an editing support program which causes a computer to execute a process, the process including obtaining, from a specified command statement included in a first source code, information designating a second source code and a first replacement rule by which a text included in the second source code is replaced, the specified command statement being a command statement for importing the second source code into the first source code, specifying a storage location of the second source code based on the obtained information designating the second source code, obtaining the second source code based on the storage location, generating a third source code by substituting the text included in the second source code in accordance with the first replacement rule, when editing to the third source code is accepted, generating a fourth source code by substituting a text included in the third source code in accordance with a second replacement rule, the second replacement rule indicating a replacement opposite to the first replacement rule, and updating the second source code stored in the specified storage location to the fourth source code.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an editing support device of an embodiment;

FIG. 2 is a flowchart illustrating an example of a flow of a process of the embodiment;

FIG. 3 is a flowchart illustrating an example of a process of step S1 in FIG. 2;

FIGS. 4A to 4C are diagrams illustrating an example of replacement rule information;

FIG. 5 is a flowchart illustrating an example of a process of step S2 in FIG. 2;

FIG. 6 is a diagram illustrating an example of a second source code and analysis information thereof;

FIG. 7 is a flowchart illustrating an example of a process of step S3 in FIG. 2;

FIG. 8 is a diagram illustrating an example of analysis information after replacement;

FIG. 9 is a flowchart illustrating an example of a process of step S4 in FIG. 2;

FIG. 10 is a diagram illustrating an example of analysis information after replacement and a pseudo source code;

FIG. 11 is a flowchart illustrating an example of a process of step S5 in FIG. 2;

FIG. 12 is a diagram illustrating an example of a pseudo source code after a change and analysis information;

FIG. 13 is a flowchart illustrating an example of a process of step S6 in FIG. 2;

FIG. 14 is a diagram illustrating an example of updating of the second source code;

FIG. 15 is a diagram illustrating an example of a process in a case where a second source code text buffer is changed; and

FIG. 16 is a diagram illustrating an example of a hardware configuration of the editing support device.

### DESCRIPTION OF EMBODIMENT

In maintenance work of a source code, there is a case where another source code is imported into the source code. In a case where a specific text of a source code file is replaced and imported to another text, a pseudo and temporary file is displayed and the file becomes read-only.

For example, there is a case where if a large source code file is imported, editing of another source code (an original source code file of a replacement source) is desired to be performed with reference to contents of the replaced source code file. In this case, for example, while opening the other source code by another editor and comparing contents of both the other source code and the replaced read-only source code, it is preferable to find and edit positions desired to be changed and it takes time and effort.

As one aspect, an object of the present embodiment is to simplify editing work of a source code.

Example of Configuration of Editing Support Device of Embodiment

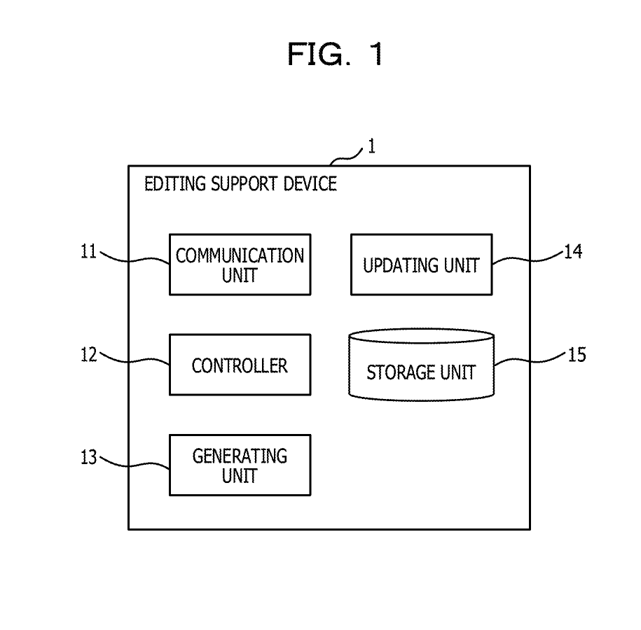

Hereinafter, the embodiment will be described with reference to drawings. FIG. 1 is a diagram illustrating an example of an overall configuration of an editing support device of the embodiment. An editing support device 1 includes a communication unit 11, a controller 12, a generating unit 13, an updating unit 14, and a storage unit 15.

In a case where a source code stored in another device is desired to be imported, the communication unit 11 receives the source code. In the embodiment, a source code written by COBOL is used, but a language used for the source code is not limited to COBOL.

The controller 12 performs various processes in the editing support device 1.

When designation of a command statement (for example, a COPY statement) for importing a second source code (different from a first source code) into the first source code among command statements included in the first source code is accepted, the generating unit 13 analyzes the designated command statement. The generating unit 13 obtains information (for example, file name) designating the second source code and a replacement rule for replacement of a text included in the second source code, which are included in the command statement. Further, based on the obtained information designating the second source code, the generating unit 13 specifies a storage location of the second source code and obtains the second source code from the specified storage location. In the embodiment, it is assumed that a storage location is the storage unit 15.

The generating unit 13 applies the obtained replacement rule to the source code obtained by the generating unit 13 and generates a third source code. The third source code is a source code pseudo-representing contents of the second source code to which a replacement rule is applied, and hereinafter there is a case where the third source code is referred to as “pseudo source code”.

When editing (change) to the generated third source code is accepted, the updating unit 14 applies a replacement rule opposite to the obtained replacement rule to a pseudo source code after editing and generates a new source code. A new source code is a temporary text for updating the second source code, and hereinafter there is a case where the new source code is referred to as “temporary text”.

The updating unit 14 updates a source code stored in the specified storage location (storage unit 15) by the generated new source code.

The storage unit 15 stores various types of data such as a first source code, a second source code, a pseudo source code, a temporary text, and the like used in the embodiment. The storage unit 15 may not store all of data described above or the communication unit 11 may obtain some pieces of data from an external storage device.

The controller 12, the generating unit 13, and the updating unit 14 in the editing support device 1 may be configured to be included, for example, in an editor of an integrated development environment (IDE) of COBOL. In this case, communication can be performed among a plurality of editors existing in the IDE, and, for example, editing contents performed by one editor may be notified to other editors.

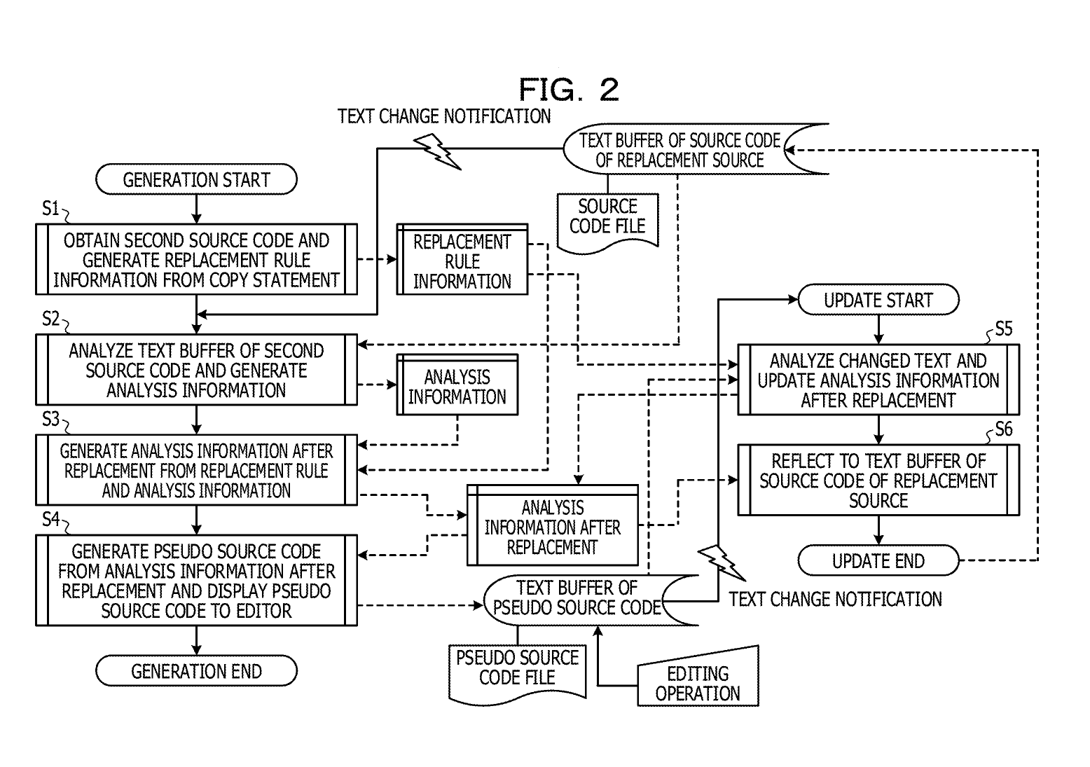

FIG. 2 is a flowchart illustrating an example of a flow of a process of the embodiment. Processes of steps S1 to S4 in FIG. 2 are started, for example, in a case where a user selects a COPY statement of a certain source code and instructs to refer to a source code (second source code) designated in the COPY statement.

The generating unit 13 obtains the second source code and generates replacement rule information from the COPY statement (step S1). The generating unit 13 analyzes a text buffer of the second source code and generates analysis information (step S2). The generating unit 13 generates analysis information after replacement from the generated replacement rule information and the analysis information (step S3). The generating unit 13 generates a pseudo source code (third source code) from the analysis information after replacement and displays the pseudo source code to an editor (step S4).

Processes of steps S5 and S6 in FIG. 2 are started when a notification indicating that the pseudo source code generated in step S4 is changed (updated) by the user's editing operation is sent to the updating unit 14.

The updating unit 14 analyzes the changed text and updates the analysis information after replacement (step S5). The updating unit 14 reflects the analysis information to a text buffer of a source code of a replacement source (step S6).

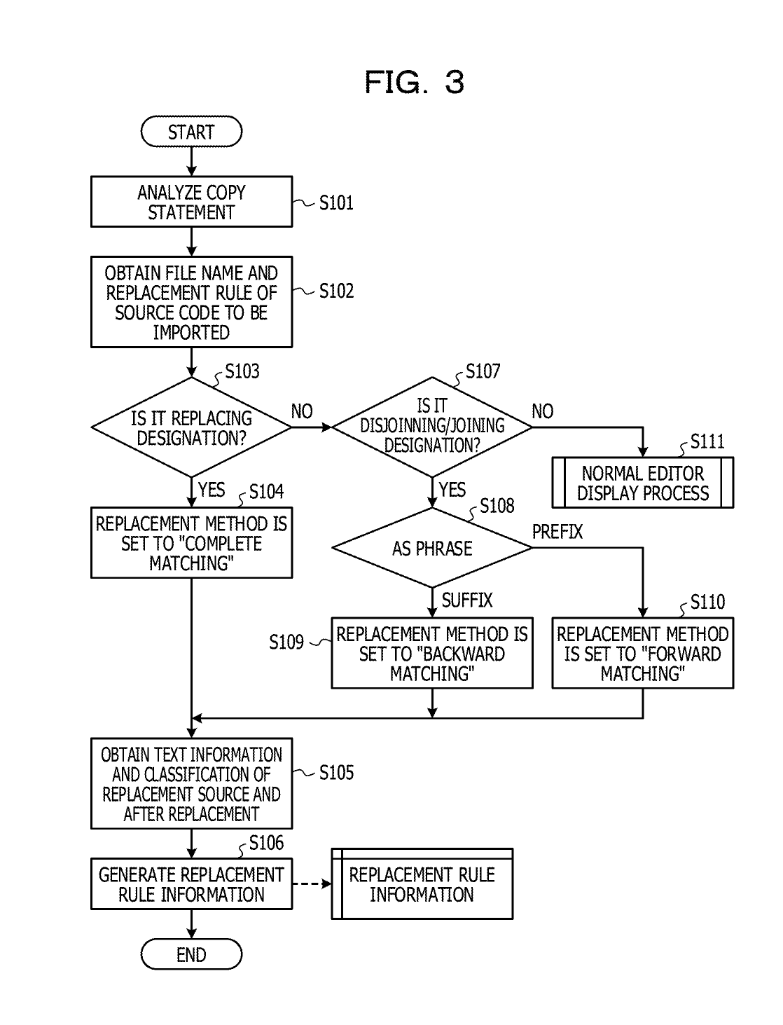

FIG. 3 is a flowchart illustrating an example of a process of step S1 in FIG. 2. The generating unit 13 analyzes the COPY statement designated by a user in command statements included in the first source code (step S101) and obtains a file name of a source code to be imported (second source code) and a replacement rule (step S102). The replacement rule is, for example, REPLACING or DISJOINNING/JOINING designation. In a case where REPLACING designation is used as a replacement rule (YES in step S103), the generating unit 13 determines that a replacement method is “complete matching” (step S104). “complete matching” used as the replacement method means that replacement is performed in a case where a text which completely matches a text designated as a text before replacement exists in the source code to be imported.

In a case where DISJOINNING/JOINING designation is used as a replacement rule (YES in step S107) and “SUFFIX” is used as an AS phrase (“SUFFIX” in step S108), the generating unit 13 determines that a replacement method is “backward matching” (step S109). “backward matching” used as the replacement method means that replacement is performed in a case where a text having at an end thereof a text designated as a text before replacement exists in the source code to be imported.

In addition, in a case where DISJOINNING/JOINING designation is used as a replacement rule (YES in step S107) and “PERFIX” is used as an AS phrase (“PERFIX” in step S108), the generating unit 13 determines that a replacement method is “forward matching” (step S110). “forward matching” used as the replacement method means that replacement is performed in a case where a text having at a head thereof a text designated as a text before replacement exists in the source code to be imported.

In a case where none of REPLACING designation and DISJOINNING/JOINING designation is used as a replacement rule (NO in step S103 and step S107), the generating unit 13 performs a normal editor process (step S111). In this case, a process described below is not performed.

After the generating unit 13 determines a replacement method in step S104, step S109, or step S110, the generating unit 13 obtains text information of a replacement source (before replacement) and after replacement and classification (step 5105) from a replacement rule. The generating unit 13 generates replacement rule information indicating a replacement rule based on text information of a replacement source and after replacement, classification, and a replacement method (step S106).

The text information is, for example, a character string of a replacement target. In addition, the classification means classification of a text of a replacement target and is, for example, an identifier, a pseudo text, and a COBOL language (language).

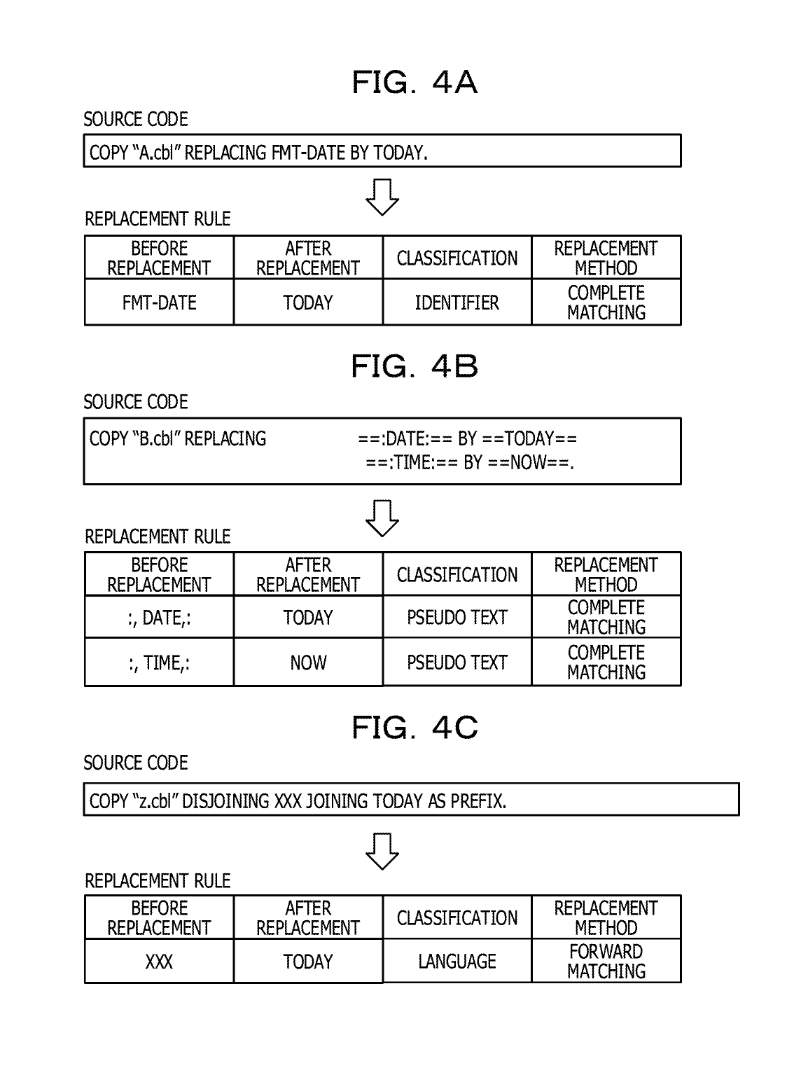

FIGS. 4A to 4C are diagrams illustrating an example of replacement rule information. FIG. 4A is an example in a case where replacement of an identifier is performed. In the example illustrated in FIG. 4A, in a case where a text (first text) which completely matches a text “FMT-DATE” exists in a source code of a replacement target, the text is replaced with “TODAY” (second text).

FIG. 4B is an example in a case where replacement of a pseudo text is performed. In a first line of a replacement rule illustrated in FIG. 4B, in a case where a text (first text) which completely matches a text “:DATE:” exists in a source code of a replacement target, the text is replaced with “TODAY” (second text). In a second line of the replacement rule illustrated in FIG. 4B, in a case where a text (first text) which completely matches a text “:TIME:” exists in a source code of a replacement target, the text is replaced with “NOW” (second text).

FIG. 4C is an example in a case where replacement of a COBOL language is performed. In a replacement rule illustrated in FIG. 4C, in a case where a text (first text) which forward-matches a text “XXX” exists in a source code of a replacement target, the text is replaced with “TODAY” (second text).

A text of a replacement target is not limited to a character, may be a symbol such as “;” and “:” and may be a combination of a character and a symbol as illustrated in the example in FIG. 4B. In addition, the text of the replacement target may include a plurality of words. Further, in the embodiment, it is assumed that the source code illustrated in FIG. 4A is used as a second source code and replacement rule information indicating a replacement rule in FIG. 4A is generated in step S106.

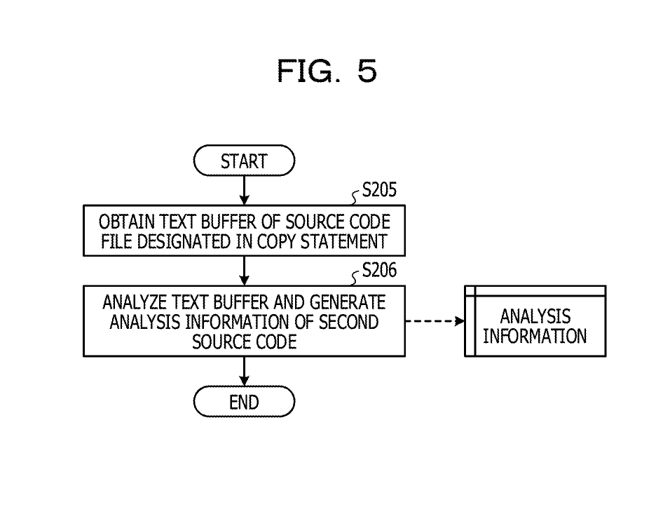

FIG. 5 is a flowchart illustrating an example of a process of step S2 in FIG. 2. The generating unit 13 obtains a text buffer of a source code (second source code) designated in a COPY statement of the first source code (step S205). In a case where the second source code is opened by an editor, the generating unit 13 obtains a text buffer from the editor. In a case where the second source code is not opened by an editor, the generating unit 13 activates a new editor and obtains a text buffer of the second source code from the editor.

The generating unit 13 analyzes the obtained text buffer and generates analysis information representing text contents of the second source code (step S206).

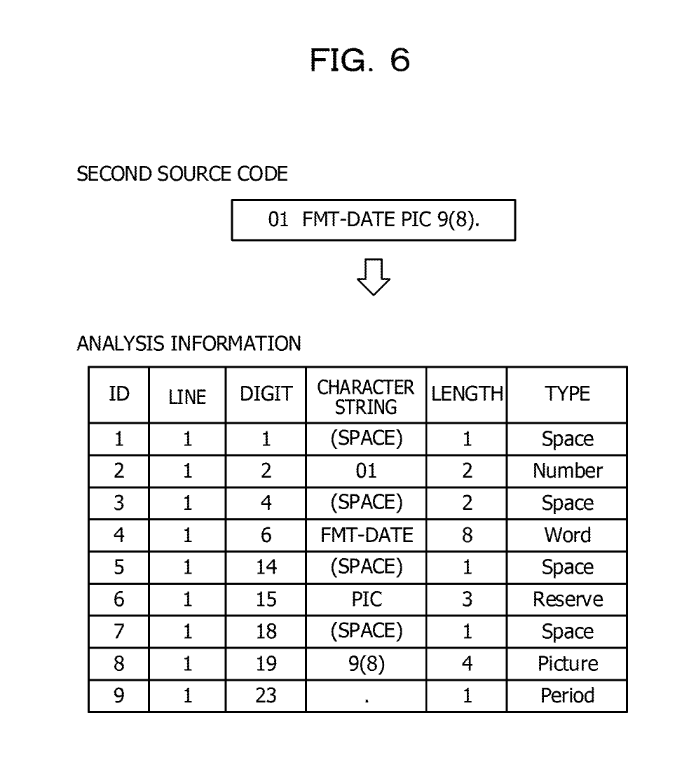

FIG. 6 is a diagram illustrating an example of a second source code and analysis information thereof. As illustrated in FIG. 6, analysis information includes an ID, a line, a digit, a character string, a length, and a type. The ID is a unique value in the source code. The line is the number of lines from a head in the source code. The digit is the number of digits from a head in a line in which a character string exists. The character string is text information and includes not only a character but also a symbol, a space, and the like. The length indicates a length of a character string (for example, the number of bytes). The type indicates a type of a character string.

For example, the generating unit 13 recognizes a space and a line feed of the second source code as a delimiter position of phrases and obtains information for each of the phrases. The generating unit 13 assigns an ID to the obtained information and adds a line, a digit, a character string, a length, and a type to the obtained information. Information included in analysis information is not limited to an example illustrated in FIG. 6, but since a source code is generated from analysis information in a process described below, at least information for generating the source code is included.

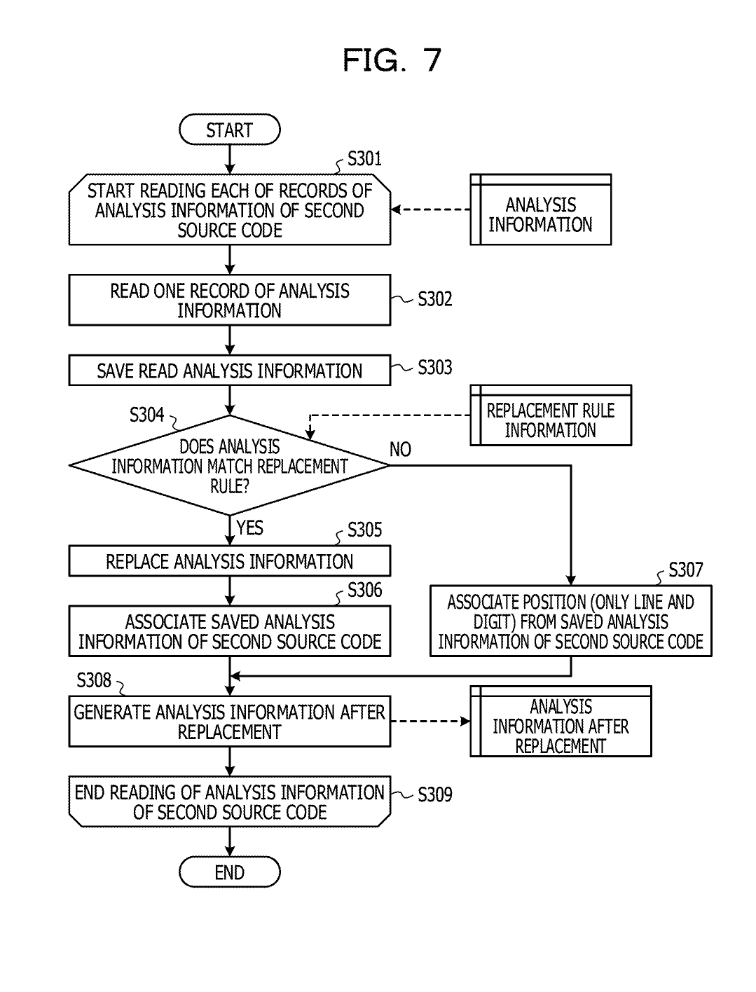

FIG. 7 is a flowchart illustrating an example of a process of step S3 in FIG. 2. The generating unit 13 starts a reading process of analysis information of the second source code generated in step S2 in FIG. 2 (step S301). The generating unit 13 reads one record (one line) in order of IDs from records, of which reading is not ended, among the obtained analysis information (step S302). The generating unit 13 saves the read analysis information (step S303). In step S303, for example, the generating unit 13 temporary stores the analysis information in the storage unit 15.

The generating unit 13 obtains replacement rule information of a COPY statement of the first source code generated in step Si in FIG. 2 and determines whether or not analysis information read in step S302 matches a replacement rule (step S304). In a case where the analysis information matches the replacement rule (YES in step S304), the generating unit 13 replaces a character string of the analysis information base on the replacement rule (step S305). For example, in a case where a replacement method is “complete matching”, the generating unit 13 determines whether or not a character string of the analysis information completely matches information represented in “before replacement” in replacement rule information. In a case where the character string of the analysis information completely matches the information represented in “before replacement”, the generating unit 13 replaces the character string of the analysis information with information represented in “after replacement”.

The generating unit 13 associates the saved analysis information of the second source code with the replaced character string (step S306).

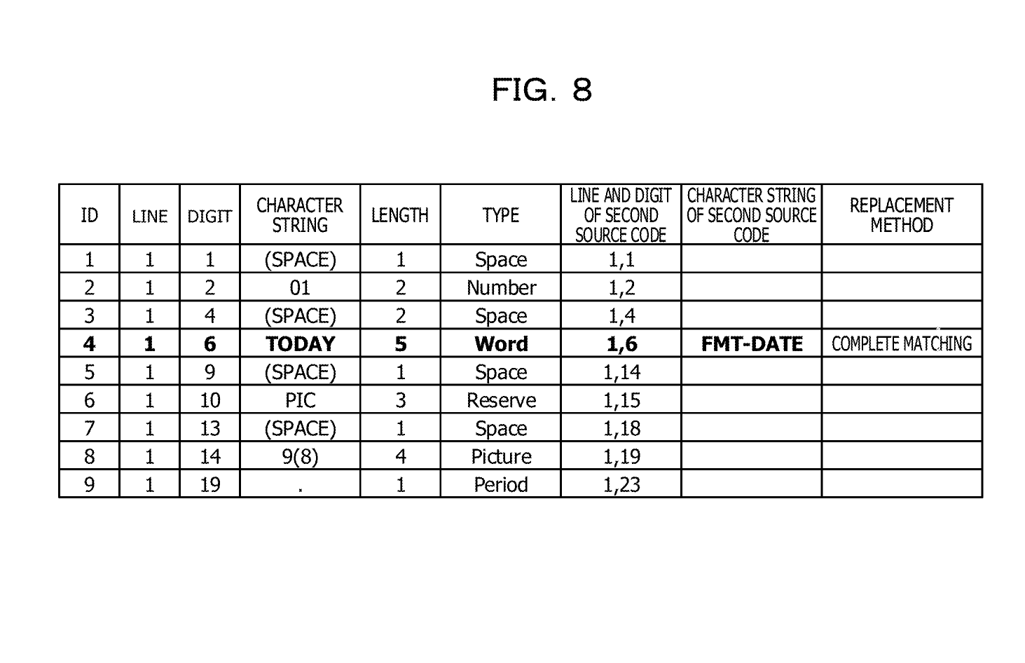

FIG. 8 is a diagram illustrating an example of analysis information after replacement. In step Si in FIG. 2, the replacement rule illustrated in FIG. 4A is generated as a replacement rule. For this reason, a character string of a record of which an ID is “4” is “FMT-DATE” in analysis information before replacement illustrated in FIG. 7, but is replaced with “TODAY” by a process of step S305.

In addition, in the example illustrated in FIG. 8, the generating unit 13 associates a line, a digit, and a character string (character string before replacement) of the second source code as information of the second source code with “TODAY” by a process of step S306. Further, as illustrated in FIG. 8, the generating unit 13 may associate a replacement method in replacement rule information with the replaced character string.

When the generating unit 13 associates information of the second source code with analysis information after replacement, the generating unit 13 may add a code of the information of the second source code to the analysis information after replacement and may add a link of the information of the second source code to the analysis information after replacement.

In a case where it is determined that the analysis information does not match the replacement rule (NO in step S304), the generating unit 13 associates only a position (line and digit) from the saved information of the second source code with the analysis information after replacement (step S307). In the example illustrated in FIG. 8, in character strings of IDs 1 to 3 and 5 to 9, only a line and a digit among the information of the second source code are associated with the analysis information after replacement.

The generating unit 13 generates analysis information after replacement for a corresponding record and outputs the analysis information (step S308). When reading of analysis information is end for all of records, the generating unit 13 ends reading of analysis information of the second source code (step S309) and repeats the processes of steps S302 to S308 if there is an unread record.

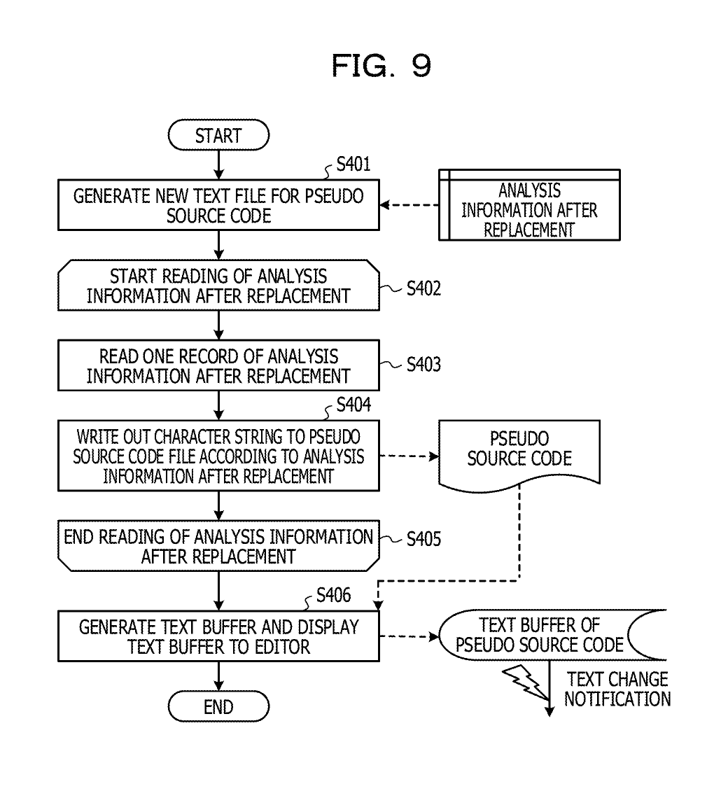

FIG. 9 is a flowchart illustrating an example of a process of step S4 in FIG. 2. The generating unit 13 generates a new text file as a text file for a pseudo source code so as to generate a pseudo source code in a process described below (step S401). The generating unit 13 obtains analysis information after replacement generated in step S3 in FIG. 2 and starts reading each of records (step S402).

The generating unit 13 reads one record from unread records among the obtained analysis information after replacement (step S403). The generating unit 13 writes out a text to a pseudo source code file (file generated in step S401) according to analysis information after replacement illustrated in FIG. 8 (step S404).

The generating unit 13 repeats the processes of steps S403 and S404 for all the records. When reading all of records of analysis information after replacement is end, the generating unit 13 ends a repeating process (step S405).

The generating unit 13 generates a text buffer of the generated pseudo source code and displays the text buffer to an editor (step S406).

By displaying the pseudo source code in the editor in the process described above, a user can refer to a source code to be imported by a COPY statement in a state where replacement is performed by a replacement rule.

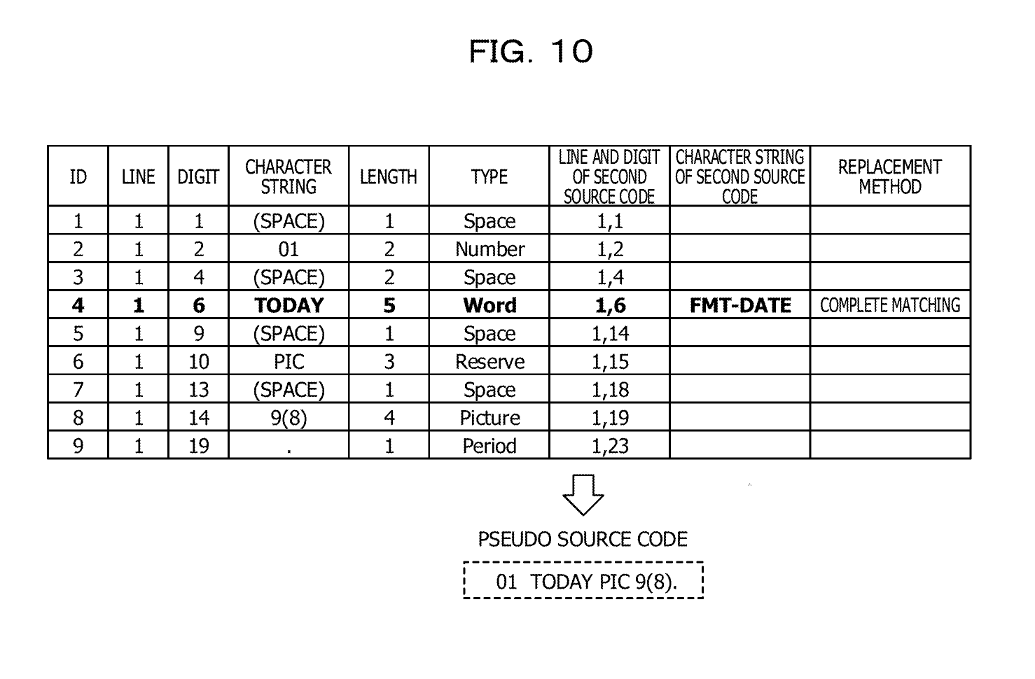

FIG. 10 is a diagram illustrating an example of analysis information after replacement and a pseudo source code. The pseudo source code illustrated in FIG. 10 is a text in which “FMT-DATE” in the second source code illustrated in FIG. 6 is replaced with “TODAY”.

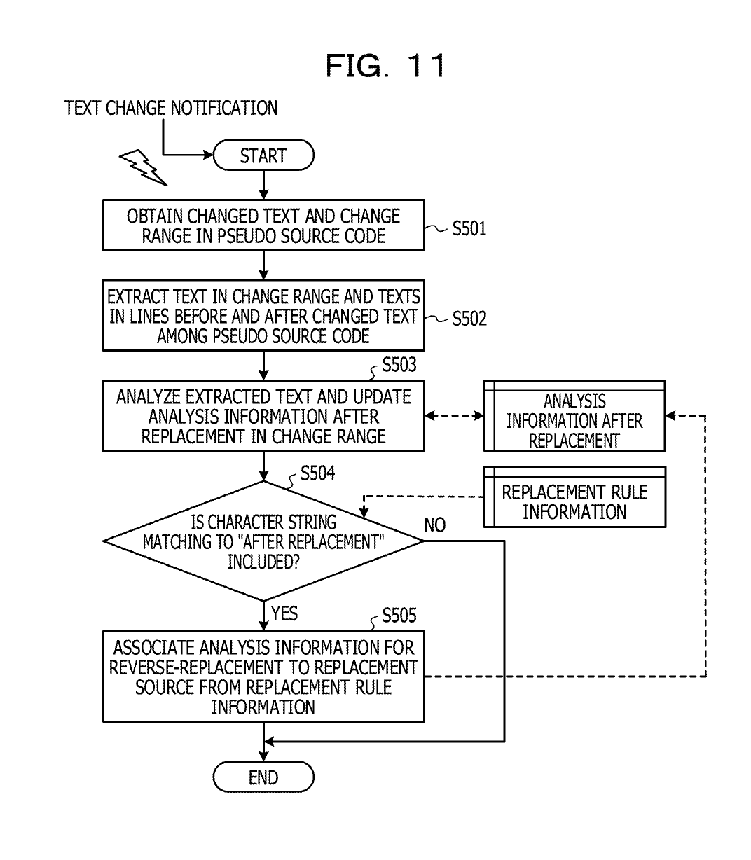

FIG. 11 is a flowchart illustrating an example of a process of step S5 in FIG. 2. The process of step S5 is started when the updating unit 14 receives a notification (text change notification) indicating that editing (change) is performed to a text buffer of the pseudo source code generated in step S4. When the text change notification is received, the updating unit 14 obtains information (position information) indicating a changed text and a change range (step S501).

The updating unit 14 extracts a text in the change range and texts in lines before and after the changed text among the text buffers of the pseudo source code (step S502). The lines before and after the text extracted in step S502 are, for example, one line before and after the changed text, but the number of extracted lines is not limited to one line before and after the text in the change range. By extracting lines before and after replacement, a location in which analysis information is updated by the updating unit 14 in a process described below becomes clear.

The updating unit 14 analyzes the extracted text and updates analysis information after replacement in the change range (step S503). The updating unit 14 determines whether or not a character string corresponding to a text of “after replacement” of a replacement rule is included in the changed text (step S504). The character string corresponding to the text of “after replacement” of the replacement rule is “TODAY” in the example in FIG. 4A.

In a case where the character string corresponding to the text of “after replacement” of the replacement rule is included, the updating unit 14 associates the character string with analysis information for reverse-replacement to the second source code from replacement rule information (step S505). Reverse-replacement means that a replacement rule opposite to the obtained replacement rule is applied. For example, in a case where “FMT-DATE” is replaced with “TODAY” by a certain replacement rule, a process by reverse-replacement is to replace “TODAY” with “FMT-DATE”. Analysis information for reverse-replacement of the second source code is a text of an item of “before replacement” of replacement rule information and is “FMT-DATE” in the example illustrated in FIG. 4A.

When associating information of the second source code, if a text of the second source code is overlapped, the updating unit 14 displays candidates and causes a user to select a candidate. For example, in a case where there are both of a replacement rule for substituting “FMT-DATE” with “TODAY” and a replacement rule for substituting “DATE” with “TODAY”, the updating unit 14 causes the user to select either of “FMT-DATE” and “DATE” as analysis information for reverse-replacement.

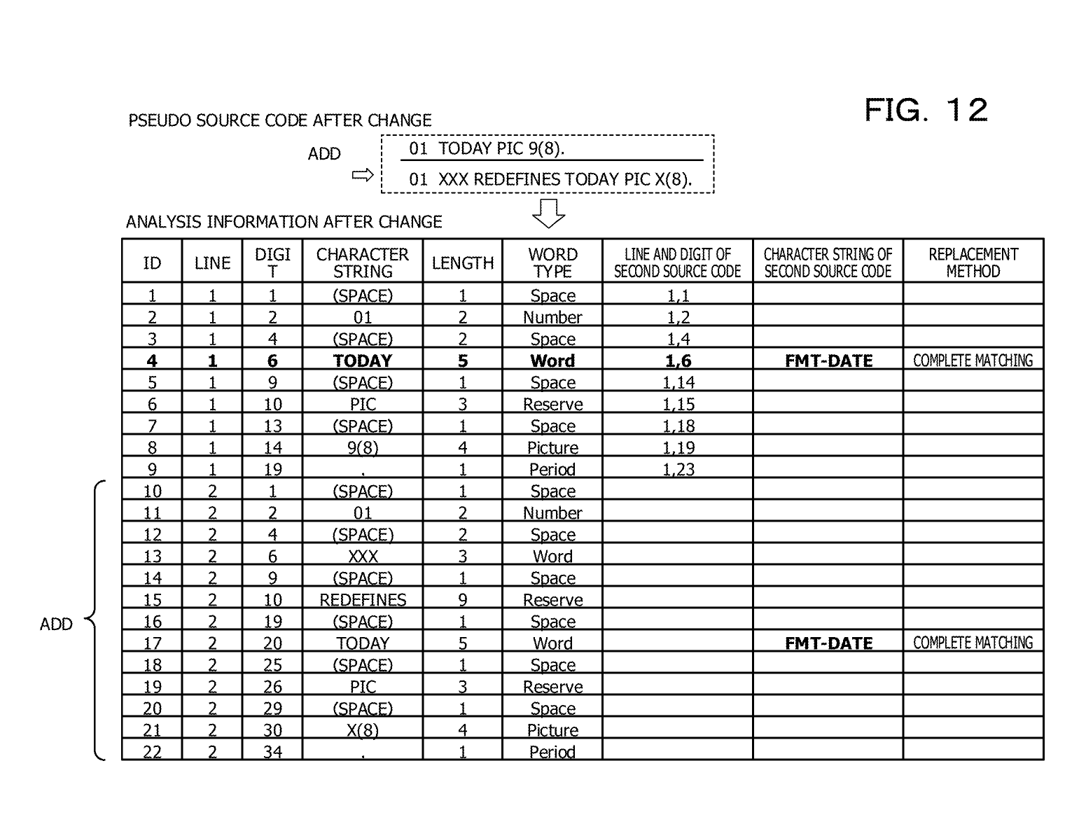

FIG. 12 is a diagram illustrating an example of a pseudo source code after a change and analysis information. In the example illustrated in FIG. 12, editing in which a text of “01 XXX REDEFINES TODAY PIC X(8).” is added to the pseudo source code is performed.

In this case, the updating unit 14 adds information indicating the added text to analysis information. In the example illustrated in FIG. 12, records of IDs 10 to 22 are added. In addition, a character string is “TODAY” in ID 17 and corresponds to a text of “after replacement” of a replacement rule illustrated in FIG. 4A. For this reason, the generating unit 13 adds “FMT-DATE”, which is a text of an item of “before replacement” of replacement rule information, to “TODAY”. In addition, as illustrated in FIG. 12, the updating unit 14 may add a replacement method.

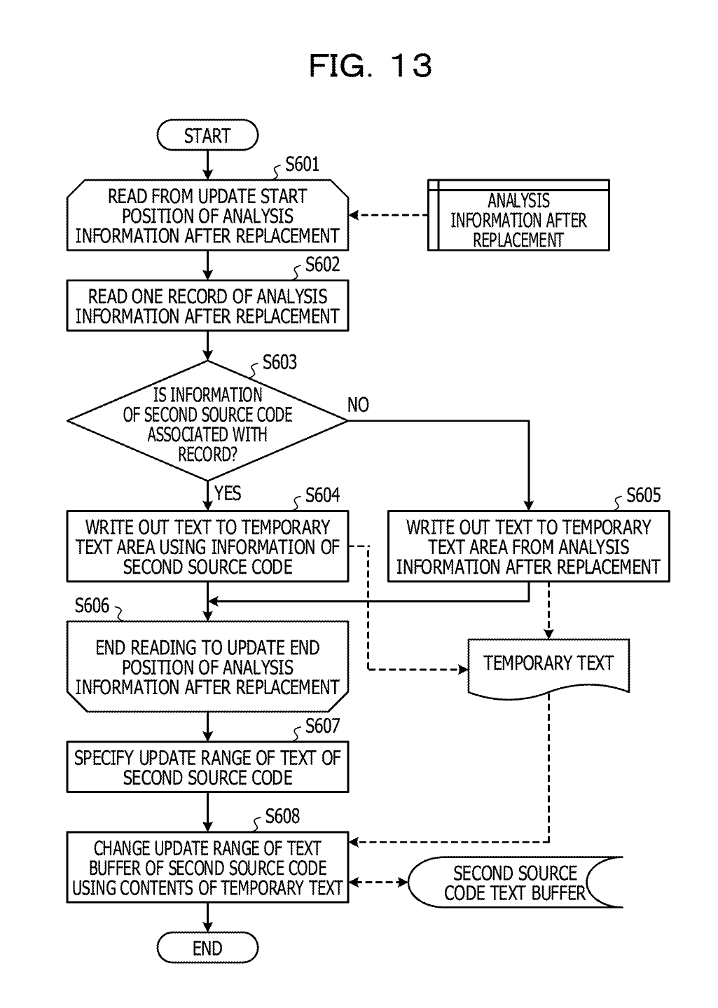

FIG. 13 is a flowchart illustrating an example of a process of step S6 in FIG. 2. The updating unit 14 obtains analysis information after replacement updated in step S5 and starts reading for one record from an update start position for each of records (step S601). The update start position of analysis information is, in the example illustrated in FIG. 12, the record of the ID 10.

The updating unit 14 reads one record of analysis information after replacement (step S602). The updating unit 14 determines whether or not information of the second source code is associated with the read record (step S603).

In a case where the information of the second source code is associated with the read record (YES in step S603), the updating unit 14 writes out a text to a temporary text using the information of the second source code (step S604). In a case where the information of the second source code is not associated with the read record, the updating unit 14 writes out a text to a temporary text using a text (a text of “character string” in the example in FIG. 12) of analysis information after replacement (step S605).

In a case where reading to an update end position of analysis information after replacement is end and a case where a repeating process is end and there is an unread record, the updating unit 14 repeats the processes of steps S602 to S605 (step S606). In the example illustrated in FIG. 12, the update end position of analysis information is the record of the ID 22.

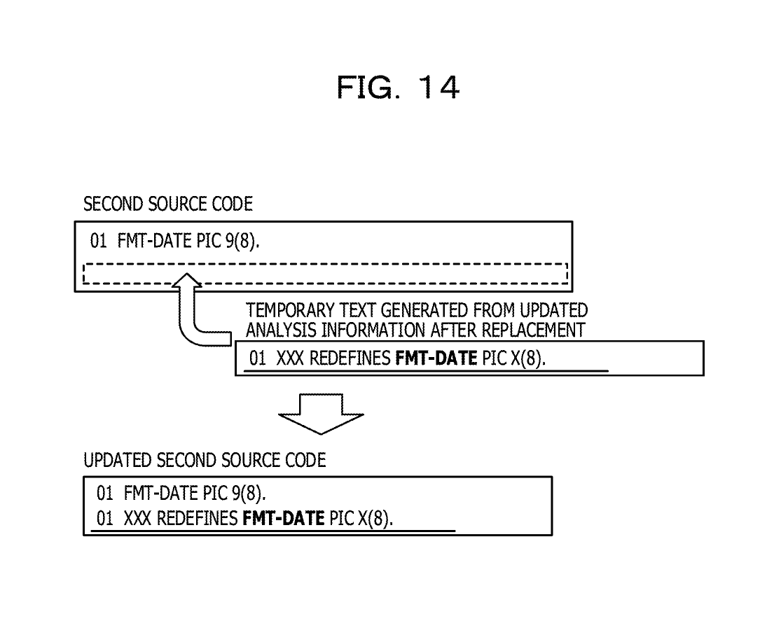

FIG. 14 is a diagram illustrating an example of updating of the second source code. Temporary texts illustrated in FIG. 14 are texts generated in the processes in steps S601 to S606 in FIG. 13. In the temporary texts illustrated in FIG. 14, a part “FMT-DATE” is a text obtained from information of the second source code in FIG. 12 and a text written out by the process of step S604. Among the temporary texts illustrated in FIG. 14, parts other than “FMT-DATE” are texts written out from “character string” of analysis information in FIG. 12 by the process of step S605.

As in the example illustrated in FIG. 14, a part “TODAY” in a pseudo source code illustrated in FIG. 12 is replaced with “FMT-DATE” and becomes a state to which a replacement rule opposite to the replacement rule is applied.

Based on information of the second source code associated with a record before or after an update range of analysis information after replacement, the updating unit 14 specifies the update range of a text of the second source code (step S607). In the example in FIG. 12, the update range is the IDs 10 to 22 and positions (lines) of the second source code associated with the IDs 1 to 9 before the update range are 1. That is, the updating unit 14 can specify that the added texts shown in IDs 10 to 22 are second lines of the second source code.

For example, there is a case where when a line is deleted in a pseudo source code, a position of a certain text in the pseudo source code is different from a position of the text in the second source code. However, since the position of the second source code is associated with analysis information after a change, the updating unit 14 can easily specify that to which position of the second source code a position of the text updated in the pseudo source code corresponds.

By checking whether or not contents of a record before or after an update range in analysis information after a change match contents of a record before or after a part to be updated of the second source code, the updating unit 14 may check an update range of a text of the second source code. The record used by the updating unit 14 to specify an update range in step S607 is not limited to one record before or after. For example, the updating unit 14 may use each one record before and after the update range or may use each of a plurality of records before and after the update range.

The updating unit 14 changes a position of a text buffer of the second source code specified in step S607 using contents of a temporary text (step S608). In the example illustrated in FIG. 14, the updating unit 14 adds a record of “01 XXX REDEFINES FMT-DATE PIC X(8).” after a record of “01 FMT-DATE PIC 9(8).”

In a case where a save operation is performed to an editor displaying a pseudo source code, the updating unit 14 notifies a save instruction to an editor displaying the second source code and saves a file of the updated second source code.

According to the process above, a user, when importing another source code by a COPY statement, can edit the source code to be imported (second source code) by editing a pseudo source code to which a replacement rule is applied.

In addition, in a case where a text newly added to the pseudo source code includes a text after replacement in a replacement rule, the editing support device 1 updates the second source code by substituting with a text before replacement in the replacement rule. For this reason, the text newly added to the pseudo source code can be appropriately imported to the second source code.

In addition, since position information (for example, line and digit) is included, as corresponding information of the second source code, in analysis information of the pseudo source code, it is possible to specify a changed range and to update an appropriate part of the second source code.

Further, by associating the information of the second source code with the analysis information after replacement, error checking also becomes easy. For example, in a case where there is a replacement rule by which “AA” is replaced with “BB”, it is assumed that “BB” is rewritten to a character string of “AA” in the pseudo source code. However, since “AA” is a replacement target of the replacement rule, if the editor after replacement is opened again, the added “AA” is replaced with “BB”. In such a case, it is desired to give a worker warning as to whether or not the part can be “BB” and let the worker to determine validity. In this case, since whether or not replacement is performed to “BB” is determined by referring to the analysis information, it is also easy to determine validity.

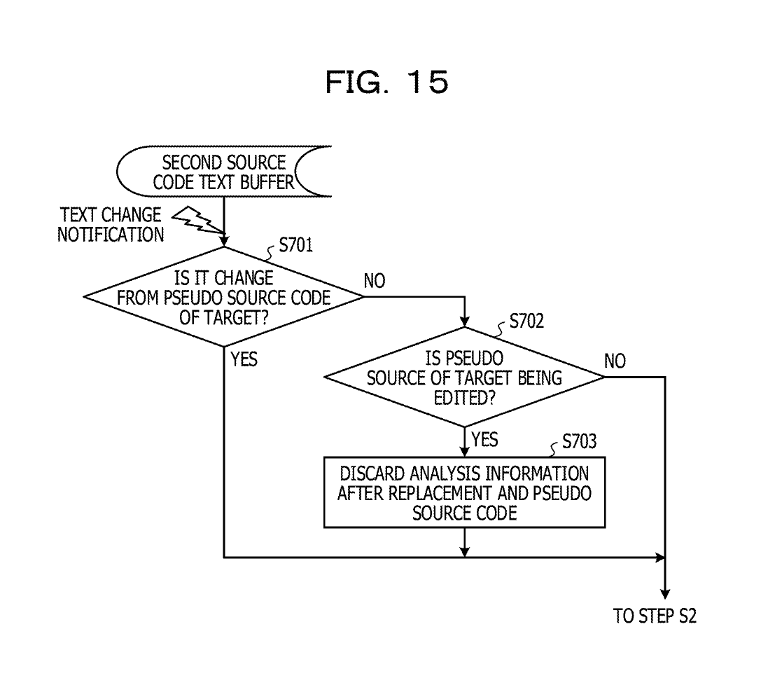

FIG. 15 is a diagram illustrating an example of a process in a case where the second source code text buffer is changed.

In a case where a notification indicating that the second source code text buffer is changed is sent from the editor displaying the second source code, the controller 12 determines whether or not the change is a change from a pseudo source code (temporary text based on the pseudo source code) of a control target (step S701). In a case where the change is not a change from the pseudo source code (temporary text) of the control target, the controller 12 determines whether or not the pseudo source of the control target is being edited (step S702). In a case of being edited, the controller 12 discards the analysis information after replacement and the pseudo source code (step S703). In step S704, the controller 12 may make a user confirm whether to discard the analysis information and the pseudo source code or to continue the process as it is before discarding the analysis information and the pseudo source code.

In a case where the change is not a change from the pseudo source code of the control target, for example, it is considered that there is a plurality of pseudo source codes and other pseudo source codes are edited. In a case where the pseudo source code of the control target is being edited, if the second source code is updated with the pseudo source code of the control target, editing to the other pseudo source code may be overwritten.

For this reason, the controller 12 discards analysis information after replacement by the process in step S703 and regenerates analysis information using the edited second source code by shifting to step S2 in FIG. 2. Accordingly, for example, even if the plurality of pseudo source codes are edited in parallel, it is possible to avoid overwriting editing of other pseudo source code by editing of the pseudo source code of the control target.

Example of Hardware Configuration of Device

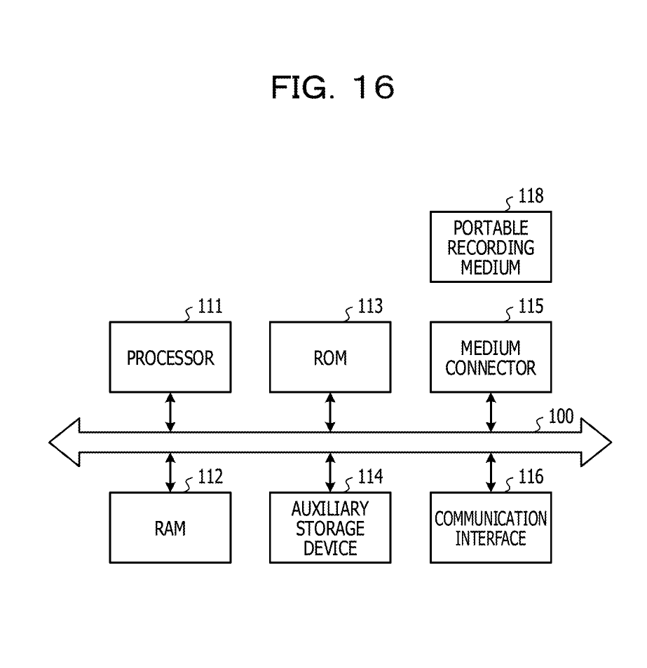

Next, an example of a hardware configuration of the editing support device will be described with reference to an example in FIG. 16. As illustrated in the example in FIG. 16, a processor 111, a random access memory (RAM) 112, and a read only memory (ROM) 113 are connected with a bus 100. In addition, an auxiliary storage device 114, a medium connector 115, and a communication interface 116 are connected with the bus 100.

The processor 111 executes a program expanded in the RAM 112. As the executed program, an editing support program for performing the processes in the embodiment may be applied.

The ROM 113 is a non-volatile storage device storing the program expanded in the RAM 112. The auxiliary storage device 114 is a storage device which stores various types of information. For example, a hard disk drive, a semiconductor memory, or the like may be applied to the auxiliary storage device 114. The medium connector 115 is provided so as to be connectable to a portable recording medium 118.

As the portable recording medium 118, a portable memory or an optical disc (for example, a compact disc (CD), a digital versatile disc (DVD), a semiconductor memory, or the like) may be applied. An editing support program for performing the processes of the embodiment may be recorded on the portable recording medium 118.

The storage unit 15 illustrated in FIG. 1 may be realized by the RAM 112, the auxiliary storage device 114, or the like. In addition, the communication unit 11 illustrated in FIG. 1 may be realized by the communication interface 116. Further, the controller 12, the generating unit 13, and the updating unit 14 illustrated in FIG. 1 may be realized by the processor 111 executing a given editing support program.

All of the RAM 112, the ROM 113, the auxiliary storage device 114, and the portable recording medium 118 are examples of computer-readable storage media. These types of storage media are not temporary media such as a signal carrier wave.

Others

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, replacements, and alterations could be made hereto without departing from the spirit and scope of the invention.

What is claimed is:

1. A non-transitory computer-readable storage medium storing an editing support program which causes a computer to execute a process, the process comprising:
obtaining, from a specified command statement included in a first source code, information designating a second source code and a first replacement rule by which a text included in the second source code is replaced, the specified command statement being a command statement for importing the second source code into the first source code;
specifying a storage location of the second source code based on the obtained information designating the second source code;
obtaining the second source code based on the storage location;
generating a third source code by substituting the text included in the second source code in accordance with the first replacement rule;
when editing to the third source code is accepted, generating a fourth source code by substituting a text included in the third source code in accordance with a second replacement rule, the second replacement rule indicating a replacement opposite to the first replacement rule; and
updating the second source code stored in the specified storage location to the fourth source code.

2. The non-transitory computer-readable storage medium according to claim 1, the process comprising:
obtaining a replacement rule by which a first text is replaced with a second text;
generating first analysis information representing text contents included in the second source code;
substituting the first text, included in the second source code, with the second text when the first text is included in the analysis information;
generating second analysis information included in the second source code after the substituting of the first text;
generating the third source code based on the second analysis information;
when editing to the third source code is accepted, updating the second analysis information based on contents in an editing range corresponding to the editing;
when the second text is included in the editing range, associating the first text with the second text in the second analysis information;
generating the fourth source code including contents in the editing range in which the second text is replaced with the first text based on the second analysis information after the associating;

3. The non-transitory computer-readable storage medium according to claim 2, the process further comprising:
generating the second analysis information by associating position information in the second source code with the first analysis information; and
specifying a position in the second source code updated by the updating the second source code to the fourth source code.

4. The non-transitory computer-readable storage medium according to claim 1, the process further comprising:
when an update of the second source code not based on the third source code is occurred during the third source code is being edited, discarding the third source code and the second analysis information.

5. An editing support method executed by a computer, the editing support method comprising:
obtaining, from a specified command statement included in a first source code, information designating a second source code and a first replacement rule by which a text included in the second source code is replaced, the specified command statement being a command statement for importing the second source code into the first source code;
specifying a storage location of the second source code based on the obtained information designating the second source code;
obtaining the second source code based on the storage location;
generating a third source code by substituting the text included in the second source code in accordance with the first replacement rule;
when editing to the third source code is accepted, generating a fourth source code by substituting a text included in the third source code in accordance with a second replacement rule, the second replacement rule indicating a replacement opposite to the first replacement rule; and
updating the second source code stored in the specified storage location to the fourth source code.

6. An editing support apparatus comprising:
a memory; and
a processor coupled to the memory and the processor configured to:
obtain, from a specified command statement included in a first source code, information designating a second source code and a first replacement rule by which a text included in the second source code is replaced, the specified command statement being a command statement for importing the second source code into the first source code;
specify a storage location of the second source code based on the obtained information designating the second source code;
obtain the second source code based on the storage location;
generate a third source code by substituting the text included in the second source code in accordance with the first replacement rule;
when editing to the third source code is accepted, generating a fourth source code by substituting a text included in the third source code in accordance with a second replacement rule, the second replacement rule indicating a replacement opposite to the first replacement rule; and
update the second source code stored in the specified storage location to the fourth source code.
